(19) United States
(12) Patent Application Publication
(10) Pub. No.: US 2017/0118706 A1
(43) Pub. Date: Apr. 27, 2017

(54) METHOD IN USER EQUIPMENT FOR SELECTING ACCESS NODE IN WIRELESS COMMUNICATION ENVIRONMENT

(71) Applicant: TELEFONAKTIEBOLAGET LM ERICSSON (PUBL), Stockholm (SE)

(72) Inventors: Xiaohui WANG, Limhamn (SE); Satheesh BIKKI, Malmo (SE); Conor WHITE, Bjarred (SE)

(73) Assignee: Telefonaktiebolaget LM Ericsson (publ), Stockholm (SE)

(21) Appl. No.: 15/317,423

(22) PCT Filed: Jun. 11, 2014
(86) PCT No.: PCT/EP2014/062088

§ 371 Date: Dec. 9, 2016

(51) Int. Cl. H04W 48/20; H04W 76/02

(52) U.S. Cl. CPC H04W 48/20; H04W 76/025; H04W 84/12

(57) ABSTRACT

A method in a user equipment for selecting an access mode for an application in the user equipment. The user equipment operates in a wireless communication environment, and the wireless communication environment comprises at least one cellular network access node and at least one wireless local network access node. The method first checks whether an application is associated with one or more communication parameters. When the application is associated with one or more communication parameters, the method than selects an access mode for the application based on comparing the one or more communication parameters with respective one or more corresponding determined communication parameters. When the application is not associated with the one or more communication parameters, the user equipment selects a multiple access mode for the application.

### TECHNICAL FIELD

Embodiments herein relate to a method in a user equipment. In particular, they relate to a method in a user equipment for selecting an access mode for an application in the user equipment.

### BACKGROUND

Communication devices such as User Equipments (UE) are also known as e.g. wireless terminals, mobile terminals and/or mobile stations. User equipments are enabled to communicate or operate wirelessly in a Heterogeneous wireless communication environment comprising multiple Networks (HetNet) with access nodes, such as a cellular communications network which comprising Second/Third Generation (2G/3G) network access nodes, 3G Long Term Evolution (LTE) network access nodes, Worldwide interoperability for Microwave Access (WiMAX) network access nodes, etc. and a wireless local network, such as a Wireless Local Area Network (WLAN) with access node. The communication may be performed e.g. between two user equipments, between a user equipment and a regular telephone and/or between a user equipment and a server via a Radio Access Network (RAN) and possibly one or more core networks, comprised within the wireless communication environment.

User equipments may further be referred to as mobile telephones, cellular telephones, smart phones, laptops, tablet computers or phablets with wireless capability, just to mention some further examples. The user equipments in the present context may be, for example, portable, pocket-storable, hand-held, computer-comprised, or vehicle-mounted mobile devices, enabled to communicate voice and/or data via an access node with another entity, such as another user equipment or a server.

Nowadays, almost all user equipments are equipped with a wireless local network unit, such as a Wireless Local Area Network (WLAN) unit. The wireless local network which is a part of a wireless communications environment, provides a connection for a user equipment through an access point to the Internet usually with high bandwidth and low cost. It gives users of the user equipment the mobility to move around within a local coverage area and still be connected to the wireless local network. An access point in the wireless local network is referred hereafter as a wireless local network access node.

Rapid growth in data traffic driven by mobile applications on user equipments such as smart phones, tablets and the like has continued to strain the capacity of the wireless communications network. To provide the best experience for the users regarding quality of service, mobility, security, cost and speed etc., switching or handover between different access nodes, e.g. between a cellular access node and a wireless local network access node is common.

The current offload solution is simply going over to the WLAN when it's available. The problem with this solution is the risk of degrading the Quality of Experience (QoE) because when going over to the WLAN, which may be in an overload or weak radio condition, the throughput of the data traffic, e.g. an application running in the UE will be dropped. There is also a network based solution, where the WLAN controller compares the throughput of an application running in the UE, for example, via an LTE network access node to an expected value via an WLAN access node to decide if the UE's admission is deferred. This means that the UE is not allowed to access the WLAN access node based on mobile network defined throughput values for a WLAN access node. Despite the complicated efforts with new interfaces between the WLAN, the Mobility Management Entity (MME) and the cellular network access node such as a base station or an eNB. And even proprietary S1 message between eNB and MME in S1 Application Protocol, the outcome is unsecured due to the difficulty of estimating the throughput of an application running in the UE somewhere in the WLAN coverage in the WLAN controller. Moreover, when the admission of some UEs is deferred, they will add the WLAN access points or nodes in their black-list, and not attempt to admit the WLAN access points or nodes later on no matter how strong signal strength they have.

Recently there have been discussions in the third Generation Partnership Project (3GPP) standardization to set up a WLAN connections while keeping the cellular network session, e.g. a 3rd generation (3G) or 4^{th} Generation (4G) network session running until the throughput via WLAN is higher than a threshold provided by the network policy controller. The solution may be sound in theory, but rather impractical because the throughput is strongly application dependent, and the number of Applications (APPs) keeps growing. Below is a list of some popular APPs and throughput needs.

Virtual Desktops: 100 to 500 Kbps

AirPrint and AirPlay: 1 Mbps

YouTube and Netflix: 2 Mbps

WebEx and Skype Conferencing: 4 Mbps

### SUMMARY

Therefor it is an object of embodiments herein to provide an improved way of selecting a suitable access mode in a communications network.

According to a first aspect of embodiments herein, the object is achieved by a method in a user equipment for selecting an access mode for an application in the user equipment. The user equipment operates in a wireless communication environment. The wireless communication environment comprises multiple network access nodes comprising at least one cellular network access node and at least one wireless local network access node. The user equipment checks whether an application is associated with one or more communication parameters. When the application is associated with one or more communication parameters, the user equipment selects an access mode for the application based on comparing the one or more communication parameters with respective one or more corresponding determined communication parameters. When the application is not associated with the one or more communication parameters, selecting a multiple access mode for the application.

According to a second aspect of embodiments herein, the object is achieved by a user equipment for selecting an access mode for an application in the user equipment. The user equipment operates in a wireless communication environment, and the wireless communication environment comprises multiple network access nodes comprising at least one cellular network access node and at least one wireless local network access node. The user equipment is configured to check whether an application is associated with one or more communication parameters. The user equipment is further configured to select an access mode based on comparing the one or more communication parameters with one or more corresponding determined communication parameters when the application is associated with one or more communication parameters, and when the application is not associated with the one or more communication parameters, selecting a multiple access mode for the application.

Since the user equipment firstly checks whether an application is associated with a communication parameter, this means that the user equipment first checks if the application is known to the user equipment. If the application is known, i.e. the application is associated with a communication parameter, the user equipment then selects an access mode for the application based on comparing the communication parameter to a corresponding determined communication parameter. By doing in this way, the user equipment adaptively selects the access mode for the active applications which achieves the best network usage without degrading the QoE to the users of the user equipments. In addition, since the method is implemented in the user equipment, no network controller or other entities involved, it is a simple and straightforward implementation.

Thus, embodiments herein provide an improved solution for the user equipment for selecting a most suitable access network for given applications running in the user equipment, e.g. smartphones or tablets within the coverage of the HetNet.

### BRIEF DESCRIPTION OF THE DRAWINGS

Examples of embodiments herein are described in more detail with reference to attached drawings in which:

FIG. 1 is a schematic block diagram illustrating an example of a wireless communication environment.

FIG. 2 is a schematic block diagram illustrating embodiments of a user equipment.

FIG. 3 is a flowchart depicting one embodiment of a method in a user equipment.

### DETAILED DESCRIPTION

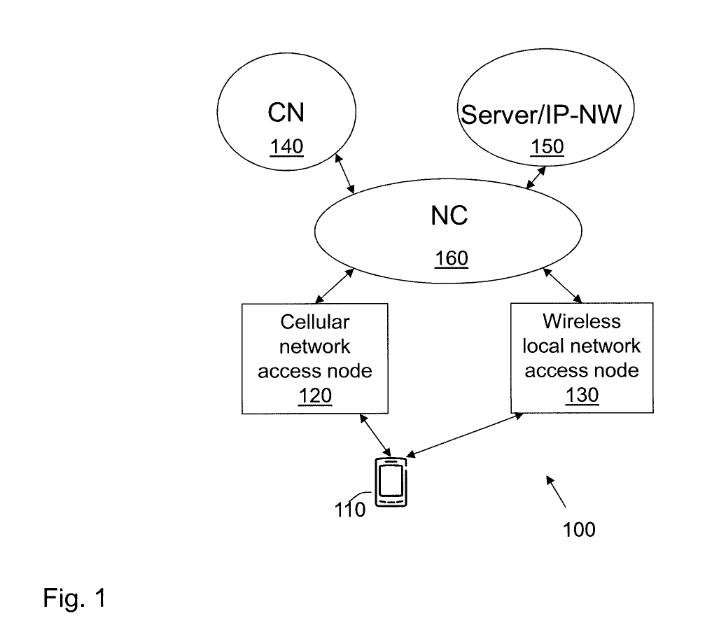

FIG. 1 depicts an example of a wireless communication environment 100 in which embodiments herein may be implemented. In some embodiments the wireless communication environment 100 may comprise one or more a communication networks such as a HetNet comprising LTE, Wideband Code Division Multiple Access (WCDMA), GSM networks, any 3GPP cellular network, Wimax, or any cellular network or system, or an IP network such as the Internet.

A number of user equipments operate in the wireless communication environment 100, whereof one, a user equipment 110 is shown in FIG. 1. The user equipment 110 may e.g. be a wireless device, a mobile terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network. Please note the term user equipment used in this document also covers other wireless devices such as Machine to machine (M2M) devices, even though they do not have any user.

The wireless communications environment 100 comprises a plurality of network access nodes whereof two, a cellular network access node 120 and a wireless local network access node 130 are depicted in FIG. 1. The cellular network access node 120 may be an eNB, an eNodeB, or a Home Node B, and Home eNode B or any other network node capable to serve a user equipment or a machine type communication device in a wireless communications network. The wireless local network access node 130 may e.g. be a WLAN access point provides a connection to the internet for a user equipment.

The wireless communications environment 100 may further comprises a Core Network, CN 140 and a Server or Internet Protocol (IP) network, Server/IP-NW 150, to communicate with the plurality of network access nodes via Network Controllers 160, e.g. one for each Radio Access Technology or a combined Network Controller.

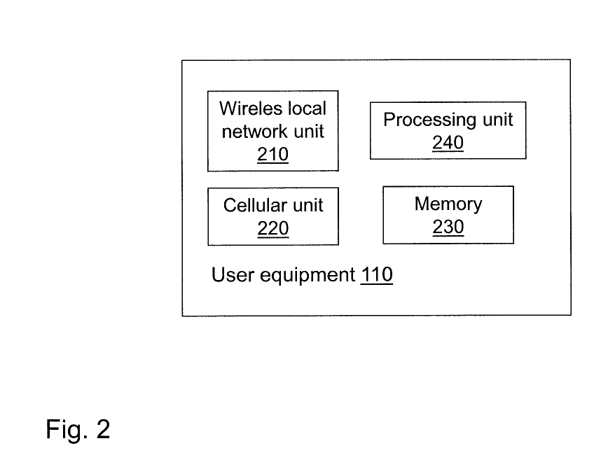

FIG. 2 depicts a simple block diagram of a user equipment 110. The user equipment 110 comprises a wireless local network unit 210, a cellular unit 220, a memory 230 and a processing unit 240. The wireless local network unit 210 provides interfaces for the user equipment 110 to the wireless local network access node 130. The cellular unit 220 provides interfaces for the user equipment 110 to the cellular network access node 120.

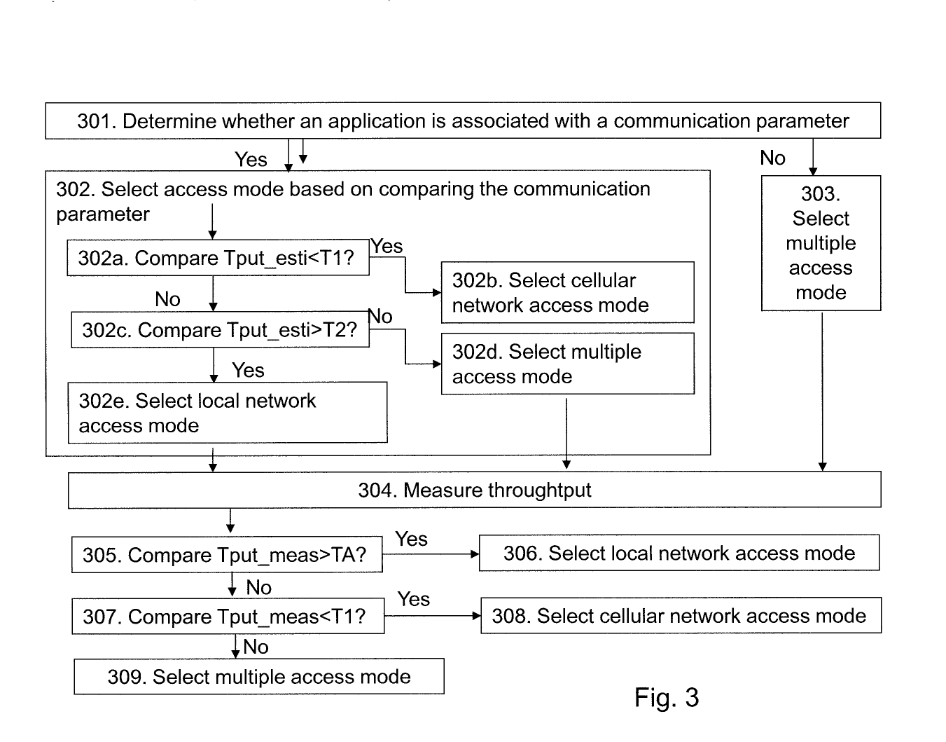

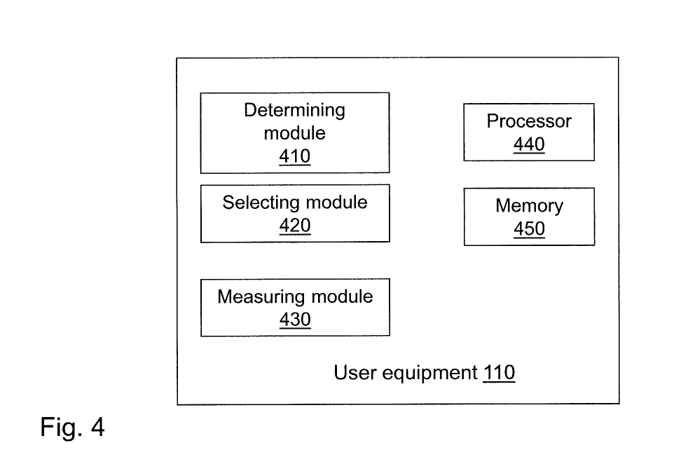

Example of embodiments of a method in the user equipment 110 for selecting an access mode for an application in the user equipment will now be described with reference to FIG. 3. As mentioned above, the user equipment 110 operates in the wireless communication environment 100 and the wireless communication environment 100 comprises multiple network access nodes comprising at least the cellular network access node 120 and the wireless local network access node 130. The method comprises the following actions, which actions may be taken in any suitable order.

Action 301

In order to select the best access node adapted for different applications in the user equipment 110, the user equipment 110 builds up a user profile by collecting the frequently used applications with corresponding one or more communication parameters, such as required throughput parameters or/and latency parameters. This predefined or built up profile list is stored in the user equipment 110. E.g. when an application is started in the user equipment 110, the user equipment 110 checks whether the application is associated with one or more communication parameters. This is done by, for example, checking whether the application and corresponding required throughput parameters are in the predefined profile list.

Action 302

When the application is associated with one or more communication parameters, i.e. the application is in the profile list and known to the user equipment 110, the user equipment selects an access mode based on comparing the one or more communication parameters with respective one or more corresponding determined communication parameters. The determined communication parameters may e.g. be estimated communication parameters or measured communication parameters. For example, the user equipment 110 compares throughput parameters estimated according to the radio and load conditions of the different access node with the collected required throughput parameters to decide which access node to be used as a preference to run the application.

Action 302a. Following action 302, i.e. when the application is in the profile list and known to the user equipment 110, the user equipment 110 further compares an estimated throughput value such as the throughput parameter for running the application via the local network access node with a first throughput threshold value, i.e. a lower bound of the throughput T1. If the estimated throughput value is denoted as Tput_esti, the required throughputs for the collected application is denoted as TA, this comparing may be expressed as Tput_esti<T1. The lower bound of the throughput T1 may be set to, for example, TA/2.

Action 302b. When the estimated throughput value for running the application via the local network access node is lower than the first throughput threshold value, i.e. Tput_esti<T1, it's better to run the application only via the cellular access node because the traffic via the WLAN would only yield bad QoE and higher power consumption. Therefore the user equipment selects a cellular network access mode for the application.

Action 302c. When the estimated throughput value for running the application via the local network access node is higher than the first throughput threshold value, i.e. Tput_esti>T1, the user equipment 110 further compares the estimated throughput value for running the application via the local network access node with a second throughput threshold value, i.e. a higher bound of the throughput T2. T2 may, for example, equal to 2*TA.

Action 302d. When the estimated throughput value for running the application via the local network access node is lower than the second throughput threshold value, i.e. Tput_esti<T2, this means the throughput via the WLAN is good but not good enough. To ensure the QoE, the user equipment 110 selects the multiple access mode for the application, i.e. the user equipment 110 runs the application via both the cellular network access node and the local network access node.

Action 302e. When the estimated throughput value for running the application via the local network access node is higher than the second throughput threshold value, i.e. Tput_esti>T2, this means the throughput via the WLAN is very good. Then it's a good choice to run the application via the WLAN to offload the traffic via the costly cellular network. Therefore the user equipment selects the local network access mode for the application.

Action 303

When the application is not associated with one or more communication parameters, i.e. the application is unknown to the user equipment 110 and cannot be find in the profile list, the best choice is to enter double radio continuity (DRC) mode in order to ensure the QoE and accuracy of the actual throughput via the WLAN as well as improve the user profile with requirements for this application. Therefor the user equipment 110 selects a multiple access mode, for example, the user equipment 110 runs the application via both the cellular network access node and the local network access node.

As a further explanation to above actions, each of the actions, Actions 302, 302a-e, and 303 which selects a multiple access mode, a cellular network access mode or a local network access mode will enable the user equipment 110 to enter into the respective access mode e.g. for a predefined period.

Moreover, to ensure the QoE, the actual throughput via the WLAN may be measured, and the measured throughput value, i.e. throughput parameter, is compared with the actual required throughput of the application to decide which access mode will be selected. Therefore, after the user equipment 110 enters into the local network access mode or the multiple access mode e.g. for a predefined period, the method may further comprise the following actions:

Action 304

The user equipment 110 measures an actual throughput, Tput_mea, for running the application via the local network access node.

Action 305

The user equipment 110 compares the measured throughput value Tput_mea for running the application via the local network access node with the required throughput value, TA, corresponding to the application.

Action 306

When the measured throughput value for running the application via the local network access node is higher than the required throughput value, i.e. Tput_mea>TA, this means the throughput via the WLAN is very good, the user equipment 110 will select the local network access mode when the user equipment 110 is in the multiple access mode. When the user equipment 110 is already in the local network access mode, it will keep running the application via the local network access node.

Action 307

When the measured throughput value for running the application via the local network access node is lower than the required throughput value, i.e. Tput_mea<TA, the user equipment 110 further compares the measured throughput value for running the application via the local network access node with the first throughput threshold value, T1.

Action 308

When the measured throughput value for running the application via the local network access node is lower than the first throughput threshold value, i.e. Tput_mea<T1, this means the throughput via the WLAN is bad, then the user equipment 110 selects the cellular network access mode for the application.

Action 309

When the measured throughput value for running the application via the local network access node is higher than the first throughput threshold value or around the required throughput value, to ensure the QoE, the user equipment selects the multiple access mode for the application.

Embodiments of the method in the user equipment 110 herein are valid no matter an application is started within a HetNet coverage or within only cellular network coverage.

Embodiments of the method in the user equipment 110 herein may extend to the wireless communication environment 100 comprising more than one local network access nodes. When the user equipment 110 enters into a local network access mode, the user equipment 110 compares estimated throughput values for running the application via the different local network access nodes. Then the user equipment 110 selects a local network access node with a highest throughput value among the estimated throughput values for running the application.

When the application is not associated with one or more communication parameters, i.e. the application is new for the user equipment 110, then the application and an associated communication parameter, e.g. required throughput, may be added into the predefined profile list stored on the user equipment (110) to improve the user profile. This may be done every time when a new application is running or started on the user equipment 110.

To perform the method actions in the user equipment 110 for selecting an access mode for an application, described above in relation to FIG. 3, the user equipment 110 comprises the following circuits depicted in FIG. 4. As mentioned above, the user equipment 110 operates in a wireless communication network 100. The wireless communication network 100 comprises multiple network access nodes comprising at least the cellular network access node 120 and the wireless local network access node 130.

The user equipment 110 is configured to, e.g. by means of a checking module 410 configured to, check whether an application started in the user equipment 110 is associated with one or more communication parameters.

The user equipment 110 is further configured to, e.g. by means of a selecting module 420 configured to, select an access mode for the application based on comparing the one or more communication parameters with respective one or more corresponding determined communication parameters when the application is associated with one or more communication parameters.

In some embodiments, the user equipment 110 is further configured to, e.g. by means of the selecting module 420 further configured to, select a multiple access mode when the application is not associated with one or more communication parameters.

In some embodiments, the user equipment 110 is further configured to, e.g. by means of the selecting module 420 further configured to, compare an estimated throughput value for running the application via the local network access node with a first throughput threshold value. When the estimated throughput value for running the application via the local network access node is lower than the first throughput threshold value, the user equipment 110 is further configured to, e.g. by means of the selecting module 420 configured to, select a cellular network access mode for the application.

When the estimated throughput value for running the application via the local network access node is higher than the first throughput threshold value, the user equipment 110 is further configured to, e.g. by means of the selecting module 420 further configured to compare the estimated throughput value for running the application via the local network access node with a second throughput threshold value. When the estimated throughput value for running the application via the local network access node is lower than the second throughput threshold value, the user equipment 110 is further configured to, e.g. by means of the selecting module 420 further configured to select the multiple access mode for the application.

When the estimated throughput value for running the application via the local network access node is higher than the second throughput threshold value, the user equipment 110 is further configured to, e.g. by means of the selecting module 420 configured to select a local network access mode for the application.

In some embodiments, the user equipment 110 is further configured to, e.g. by means of a measuring module 430 configured to, measure an actual throughput for running the application via the local network access node. The user equipment 110 is further configured to, e.g. by means of selecting module 420 further configured to, select the multiple access mode for the application, when the measured throughput value for running the application via the local network access node is higher than the first throughput threshold value or around the required throughput value.

In some embodiments, the multiple access nodes comprises more than one local network access nodes, when the user equipment enters into a local network access mode, the user equipment 110 is further configured to, e.g. by means of the selecting module 420 further configured to, compare estimated throughput values for running the application via the different local network access nodes and select a local network access node with a highest throughput value among the estimated throughput values for running the application.

Those skilled in the art will appreciate that checking module 410, selecting module 420 and measuring module 430 described above may be referred to one module, a combination of analog and digital circuits, one or more processors, such as processor 440, depicted in FIG. 4, configured with software and/or firmware and/or any other digital hardware performing the function of each module. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The user equipment may further comprise a memory 450 comprising one or more memory units. The memory 450 is arranged to be used to store obtained information, such as measurements on throughputs, predefined profile list etc. and other data, configurations to perform the methods herein when being executed in the user equipment 110.

The embodiments herein in the user equipment 110 for selecting an access mode for an application may be implemented through one or more processors, such as the processor 440 in the user equipment 110, together with computer program code for performing the functions and actions of the embodiments herein. The program code mentioned above may also be provided as a computer program product, for instance in the form of a data carrier carrying computer program code for performing the embodiments herein when being loaded into the user equipment 110. One such carrier may be in the form of a CD ROM disc. It is however feasible with other data carriers such as a memory stick. The computer program code may furthermore be provided as pure program code on a server and downloaded to the user equipment 110.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a user equipment for selecting an access mode for an application in the user equipment, which user equipment operates in a wireless communication environment, wherein the wireless communication environment comprises multiple network access nodes comprising at least one cellular network access node and at least one wireless local network access node, the method comprising:
checking whether an application is associated with one or more communication parameters;
when the application is associated with one or more communication parameters, selecting an access mode for the application based on comparing the one or more communication parameters with respective one or more corresponding determined communication parameters, and
when the application is not associated with the one or more communication parameters, selecting a multiple access mode for the application.

2. The method according to claim 1, wherein the determined communication parameters are either estimated communication parameters or measured communication parameters.

3. The method according to claim 1, wherein checking whether an application is associated with one or more communication parameters comprises checking whether the application and the one or more communication parameters are in a predefined profile list stored on the user equipment.

4. The method according to claim 1, wherein the one or more communication parameters are at least one of a throughput parameter and/or a latency parameter.

5. The method according to claim 1, wherein the one or more communication parameters comprises throughput values for running the application via different network access nodes.

6. The method according to claim 1, wherein selecting an access mode for the application based on comparing the one or more communication parameters with respective one or more corresponding determined communication parameters further comprises:
comparing an estimated throughput value for running the application via the local network access node with a first throughput threshold value;
when the estimated throughput value for running the application via the local network access node is lower than the first throughput threshold value,
selecting a cellular network access mode for the application;
when the estimated throughput value for running the application via the local network access node is higher than the first throughput threshold value,
comparing the estimated throughput value for running the application via the local network access node with a second throughput threshold value;
when the estimated throughput value for running the application via the local network access node is lower than the second throughput threshold value,
selecting the multiple access mode for the application;
when the estimated throughput value for running the application via the local network access node is higher than the second throughput threshold value,
selecting a local network access mode for the application.

7. The method according to claim 1, wherein each of the selecting a multiple access mode, a cellular network access mode and a local network access mode enables the user equipment to enter into the respective access mode for a predefined period.

8. The method according to claim 1, wherein after the user equipment enters into the local network access mode or the multiple access mode for a predefined period, the method further comprising:
measuring an actual throughput for running the application via the local network access node;
comparing the measured throughput value for running the application via the local network access node with a required throughput value corresponding to the application;
when the measured throughput value for running the application via the local network access node is higher than or equal to the required throughput value,
keeping running the application via the local network access node when the user equipment is in the local network access mode, or
selecting the local network access mode when the user equipment is in the multiple access mode;
when the measured throughput value for running the application via the local network access node is lower than the required throughput value,
comparing the measured throughput value for running the application via the local network access node with the first throughput threshold value,
when the measured throughput value for running the application via the local network access node is lower than the first throughput threshold value,
selecting the cellular network access mode for the application.

9. The method according to claim 8, further comprising:
when the measured throughput value for running the application via the local network access node is higher than the first throughput threshold value or around the required throughput value,
selecting the multiple access mode for the application.

10. The method according to claim 1, wherein the multiple access mode comprises running the application via both the cellular network access node and the local network access node.

11. The method according to claim 1, wherein the multiple access nodes comprises more than one local network access node, and wherein when the user equipment enters into a local network access mode, the method further comprising:
comparing estimated throughput values for running the application via the different local network access nodes;
selecting a local network access node with a highest throughput value among the estimated throughput values for running the application.

12. The method according to claim 1, further comprising adding the application and an associated communication parameter into the predefined profile list stored on the user equipment when the application is not associated with one or more communication parameters.

13. A user equipment for selecting an access mode for an application in the user equipment, which user equipment operates in a wireless communication environment, wherein the wireless communication environment comprises multiple network access nodes comprising at least one cellular network access node and at least one wireless local network access node, wherein the user equipment is configured to:
check whether the application is associated with one or more communication parameters;
when the application is associated with one or more communication parameters, select an access mode for the application based on comparing the one or more communication parameters with respective one or more corresponding determined communication parameters, and
when the application is not associated with one or more communication parameters, select a multiple access mode for the application.

14. The user equipment according to claim 13, wherein the one or more communication parameters are throughput values for running the application via different network access nodes.

15. The user equipment according to claim 13, wherein the user equipment is further configured to:
compare an estimated throughput value for running the application via the local network access node with a first throughput threshold value;
when the estimated throughput value for running the application via the local network access node is lower than the first throughput threshold value,
select a cellular network access mode for the application;
when the estimated throughput value for running the application via the local network access node is higher than the first throughput threshold value,
compare the estimated throughput value for running the application via the local network access node with a second throughput threshold value;
when the estimated throughput value for running the application via the local network access node is lower than the second throughput threshold value,
select the multiple access mode for the application;
when the estimated throughput value for running the application via the local network access node is higher than the second throughput threshold value,
select a local network access mode for the application.

16. The user equipment according to claim 13, wherein the user equipment further is configured to:
measure an actual throughput for running the application via the local network access node;
compare the measured throughput value for running the application via the local network access node with a required throughput value corresponding to the application;
when the measured throughput value for running the application via the local network access node is higher than the required throughput value, keeping running the application via the local network access node when the user equipment is in the local network access mode, or select the local network access mode when the user equipment is in the multiple access mode;
when the measured throughput value for running the application via the local network access node is lower than the required throughput value, compare the measured throughput value for running the application via the local network access node with the first throughput threshold value,
when the measured throughput value for running the application via the local network access node is lower than the first throughput threshold value, select the cellular network access mode for the application.

17. The user equipment according to claim 16, wherein the user equipment is further configured to:
select the multiple access mode for the application, when the measured throughput value for running the application via the local network access node is higher than the first throughput threshold value or around the required throughput value.

18. The user equipment according to claim 13, wherein the multiple access nodes comprises more than one local network access node, and wherein when the user equipment enters into a local network access mode, wherein the user equipment is further configured to:
compare estimated throughput values for running the application via the different local network access nodes;
select a local network access node with a highest throughput value among the estimated throughput values for running the application.
